(19) United States
(12) Patent Application Publication
(10) Pub. No.: US 2012/0022903 A1
(43) Pub. Date: Jan. 26, 2012

(54) SYSTEM AND METHOD FOR GENERATING ARTISTIC EVENT PLANS

(76) Inventor: Brendan Sladek, Dallas, TX (US)

(21) Appl. No.: 13/045,446

(22) Filed: Mar. 10, 2011

Related U.S. Application Data
(60) Provisional application No. 61/312,439, filed on Mar. 10, 2010.

(51) Int. Cl. G06Q 10/00

(52) U.S. Cl. 705/7.12

(57) ABSTRACT

A system and method for planning an artistic event may include receiving artistic requirements data inclusive of physical resources for an artist to perform the art form. A date range may be received for the artistic event to be performed. Geographic information defining a geographic region in which the artistic event is to be conducted may be received. Desired audience information of a desired audience to attend the artistic event may be received. Budgetary information for marketing and conducting the artistic event may be received. Based on the artistic requirements data, date range, geographic information, desired audience information, and budgetary information, an artistic event plan may be generated that includes a list of action items for conducting the event, deadlines to perform the action items, and estimated costs for the action items.

### RELATED APPLICATIONS

This application claims priority from co-pending U.S. Provisional Patent Application Ser. No. 61/312,439 filed on Mar. 10, 2010, the entire contents of which are incorporated herein by reference in their entirety.

### BACKGROUND

The media industry is a fragmented business in which professionals within the industry are loosely tied to one another via personal relationships and other relationship-based connections. New players to the industry are generally limited in their ability to “find their way,” as making the right connections when getting started is difficult. For example, an artist that is just getting started, such as a proverbial “garage” band, that needs to raise money to purchase equipment, travel to gigs, and professionally produce music and merchandise is generally limited due to not having the right connections to the industry despite having the right talent. Other types of artists, including graphical artists, authors, and other media generators, have similar problems. In the same way that media generators face industry interconnection limitations, so too do other professionals in the media industry, such as promoters, managers, studios, and so on.

While social networking websites, such as Facebook, that have been developed in the past few years have been beneficial to bands, artists, and other professionals in the media business, social networking websites are generally limited in providing for the shortcomings of reaching industry professionals as opposed to fans and other consumers of media and media services.

Moreover, young and even senior artists that desire to create an artistic event find it difficult to orchestrate such event. Event planning is difficult enough for people with event planning expertise, but new artists who are still learning their artistic craft can find it overwhelming to operate as event planning business people. In a very real sense, artists are unequipped to generate an event plan that they can then use to raise necessary capital to conduct the event and use for providing guidance in putting on the event.

### SUMMARY

To overcome the limitations of the media industry, the principles of the present invention provide for an integrated industry network online environment that allows all facets of a media sector to coordinate skills and functions with other media sector professionals to promote and manage their goods and services. The online environment provides for media sector professionals to manage their careers, industry relationships, specific jobs, legal documents, and finances so that the fragmentation of the media industry is defragmented and the business aspect of the media business is manageable.

To overcome the problem of artists having to generate event plans that can be used for raising capital to conduct the event and guide an artist in putting on the event, the principles of the present invention provide for a system and method for generating an event plan. In one embodiment, the online environment may include an event planning tool that allows a user to input information that the event planning tool can use to create an event plan. The event planning tool may use resources that are part of the online environment to enable the user to select as the information is being created. As an example, if the user enters a date range during which an event is to be conducted and budget for the event, the event planning tool may show a listing of available venues and prices of the available venues that comply with the price range for the event. In one embodiment, the event planning tool may receive the budget for the event and establish an estimated price range for a venue that satisfies the budget based on business rules that accommodates other budgetary items (e.g., marketing, mass merchandise (e.g., tee shirt production, key chain production), equipment rental, staffing, and so forth) that are to be included with conducting the event.

One embodiment for a method for planning an artistic event may include receiving artistic requirements data inclusive of physical resources for an artist to perform the art form. A date range may be received for the artistic event to be performed. Geographic information defining a geographic region in which the artistic event is to be conducted may be received. Desired audience information of a desired audience to attend the artistic event may be received. Budgetary information for marketing and conducting the artistic event may be received. Based on the artistic requirements data, date range, geographic information, desired audience information, and budgetary information, an artistic event plan may be generated that includes a list of action items for conducting the event, deadlines to perform the action items, and estimated costs for the action items. In one embodiment, the event plan may be generated with estimated budgetary amounts for different aspects of the artistic event, where the budgetary amounts may be automatically and/or manually generated as a function of a total budget.

### BRIEF DESCRIPTION OF THE DRAWINGS

Illustrative embodiments of the present invention are described in detail below with reference to the attached drawing figures, which are incorporated by reference herein and wherein:

FIG. 1 is an illustration of an illustrative artist community in which a variety of disciplines are involved;

FIG. 2 is an illustration of an illustrative online community social network in which the variety of disciplines in the artist community may interact;

FIG. 3 is a block diagram of an illustrative set of software modules that may be utilized for operating the online community social network;

FIG. 4 is a block diagram of an illustrative set of software modules for providing an event planner module;

FIGS. 5A-5E are screenshots of illustrative input screens for an artist, in this case a band, to use in planning an event; and

FIG. 6 is a flow chart of an illustrative process for generating an artistic event plan.

### DETAILED DESCRIPTION OF THE DRAWINGS

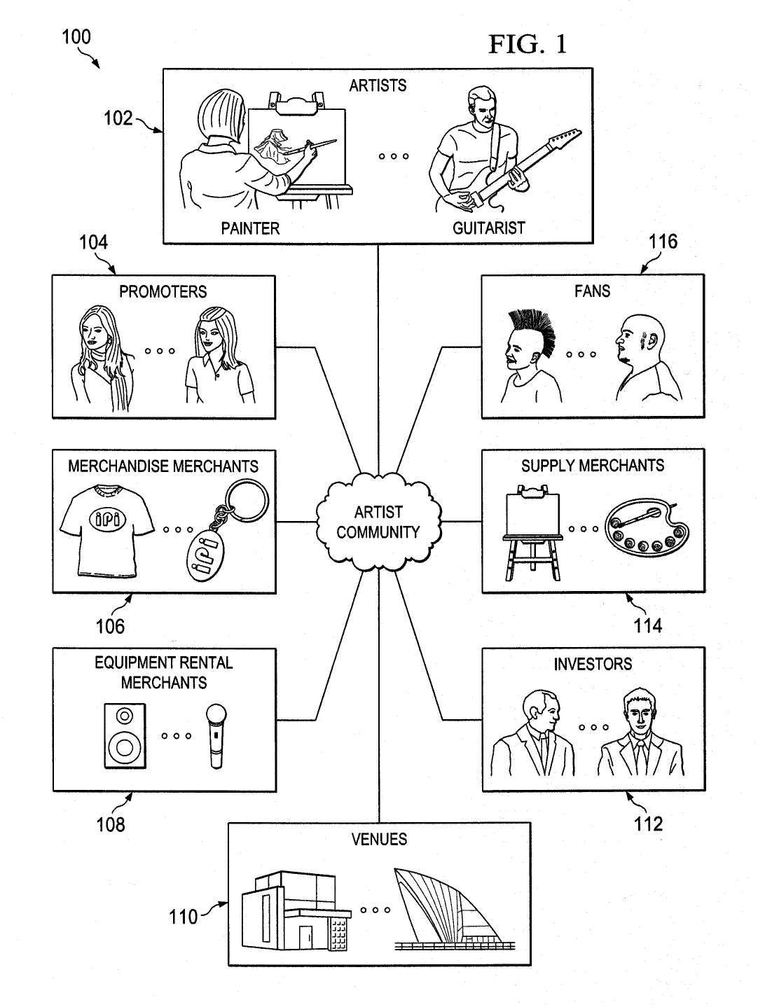

With regard to FIG. 1, an illustration of an illustrative artist community 100 in which a variety of disciplines are involved is shown. The variety of disciplines may include artists 102, promoters 104, merchandise merchants 106, equipment rental merchants 108, venues 110, investors 112, supply merchants 114, and fans 116. It should be understood that additional disciplines may be included in the artist community, including photographers, videographers, writers, actors, media, and so on. As demonstrated, there is a wide variety of disparate “players” in the artist community. Because of the wide number of disciplines, the artist community is fragmented due to a geography, connections, organizations, and so forth.

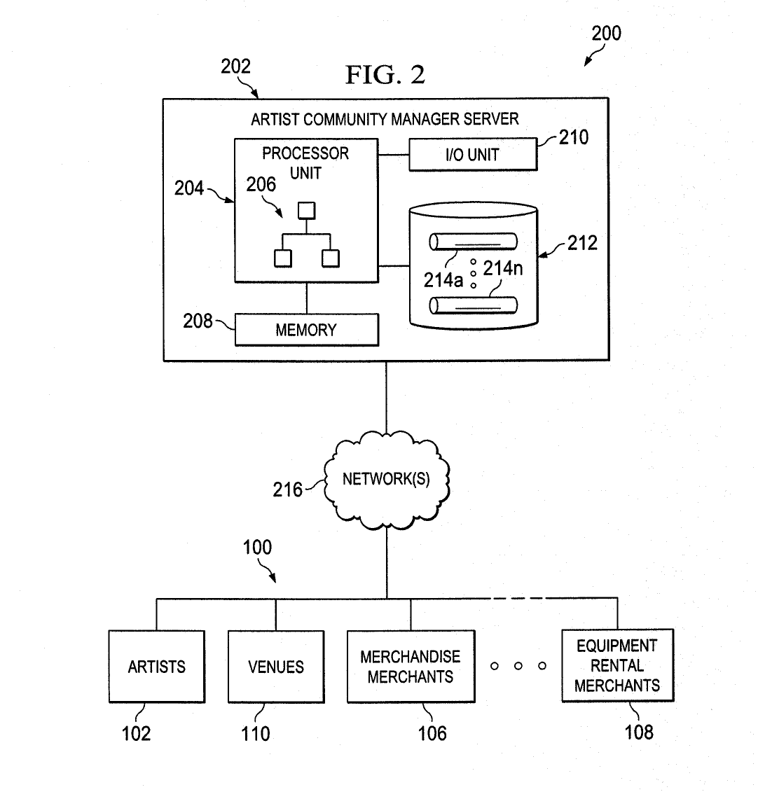

FIG. 2 is an illustration of an illustrative online community social network 200 in which the variety of disciplines in the artist community 100 may interact. The social network 200 may be managed by an artist community manager server 202 that includes a processing unit 204 that includes one or more computer processors, as understood in the art. The processing unit 204 may execute software 206 that creates the online community and provides a number software tools that enables the online community to perform business functions that are relevant to the various disciplines that are part of the artist community. The artist community manager server 202 may further include a memory 208 that is capable of storing data created by participants of the artist social network and software 206 that is being executed by the processing unit 204, an input/output (I/O) unit 210 that is configured to communicate over one or more networks, such as the Internet, and storage unit 212 configured to store data repositories 214a-214n (collectively 214). The data repositories 214 may store data that is generated by users of the online community social network 200. The users of the online community social network 200 may include the artist community 100 participants, including artists 102, venues 110, merchandise merchants 106, and equipment rental merchants 108, to name a few. As shown, one or more communications networks 216 may be utilized by the users of the online community social network 200. The communications networks 216 may include the Internet, mobile networks, satellite networks, and any other electronic network, as understood in the art.

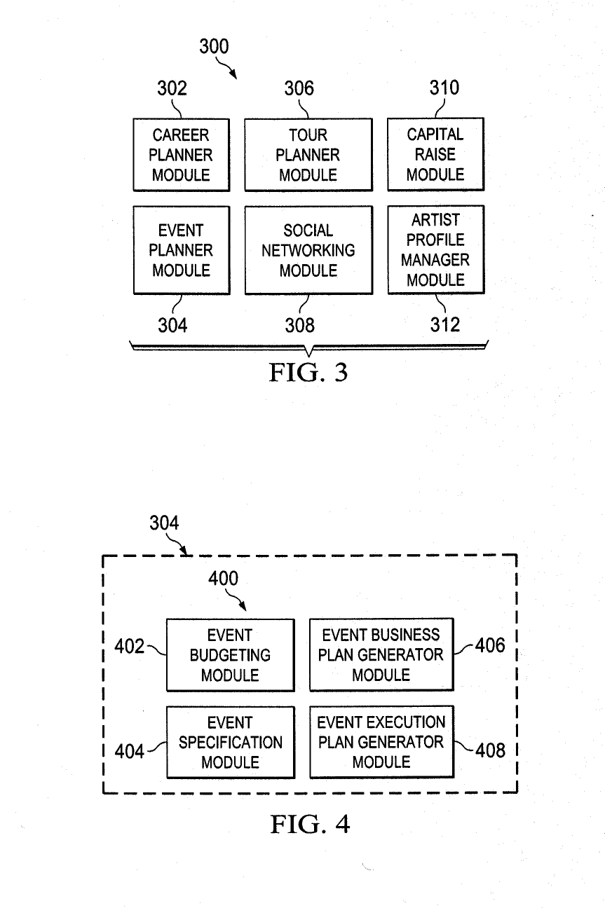

With regard to FIG. 3, a block diagram of an illustrative set of software modules 300 that may be utilized for operating the online community social network. The modules 300 may be part of the software 206 (FIG. 2) and provide for a number of different professional and social functions. The modules 300 are illustrative and should not be construed as being limiting to the online community social network.

A career planner module 302 may be configured to enable an artist to plan his or her career. As young artists are generally unsophisticated and unfamiliar with how professional careers are managed and developed, the career planner module 302 may be an invaluable asset that provides career guidance and provides mentoring, as well.

An event planner module 304 may be configured to enable a user to plan an event in which the user, who may be an artist, may also be a participant. The event planner module 304 may utilize specific input data, such as event type, artist type, etc., to generate a customized event plan that relates to the specific input data. The event planner module 304 may also be configured to enable the user to create a very general event plan or a very specific event plan depending on the desires of the user. In other words, the event planner module 304 may utilize a hierarchical listing of specific aspects of an event plan and the user may elect to expand each of the specific aspects of the event plan to create more or less detail of an event plan.

A tour planner module 306 is a module that may enable a user to generate a tour plan. Because tours have different requirements, including travel, equipment rental, personnel, financials, an so on, the tour plan module 306 can provide the user with the ability to ensure that every aspect of a tour is covered. The tour plan module 306 may provide for a tour budget to be created from tour stops or may allow the user to enter a budget and assist the user in selecting tour stops that meet the budget. Each tour stop may have an event that may be generated by using the event planner module 304. As with the event planner module 304, the tour planner module 306 may create different requirements that are specific to the discipline of different artists. As an example, a paint artist may tour galleries in different cities in which the artist's art is being displayed, while a music recording artist may play at local venues in cities in which the artist is touring. As also with the event planner module 304, the level of detail that is possible to create for a tour may range from very general to very specific depending on the needs and desire for the user to create a specific tour business plan and tour execution plan.

A social network module 308 may provide an artist or other participant in the online artist social community with a social networking presence. The social network module 308 may provide a user with typical social networking abilities, such as posting photographs, listing of profession, and so forth. In addition, the social network abilities may extend to additional levels of detail that are particular to the artist community, such as providing the ability for the user to promote professional aspects of the user's function in the art community. For example, if the user is in the equipment rental business, then the user may provide specific details as to the type of equipment that the user rents, price ranges of the equipment rentals, currently available equipment, and so on, to enable other users to be able to actively utilize the user's data to create event and tour plans that include the equipment rental details. It should be understood that a variety of different examples of artist community specific details may be utilized on the social network that are promotional as well as sharable with other users to generate business.

A capital raise module 310 may provide users with the ability to raise capital from investors. In one embodiment, the capital raise module 310 may provide a listing of opportunities from both those seeking to raise capital for a specific event, a specific tour, or to buy an equity ownership of an artist's business.

An artist profile manager module 312 may enable a user to create his or her personal and professional profile. The user may be an individual or a group (e.g., band, dance troupe, organization, etc.). The artist profile manager module 312 may allow the user to populate as many data categories as desired to have a small or large online presence. The more specific details of the user, the more specific that the system can plan events or tours. The personal inputs may include personal background (e.g., birthplace, schools, city grown up, age, gender, etc.), while the professional inputs may include trade(s), skill(s), past events, past tours, resume, availability, fees for services, and so on. The other modules 302-310 may use the inputs collected by the artist profile manager 312 to assist the user in generating outputs. In addition, if the other modules 302-310 have certain inputs, those inputs may be used to populate data records utilized by the artist profile manager module 312 or any other modules.

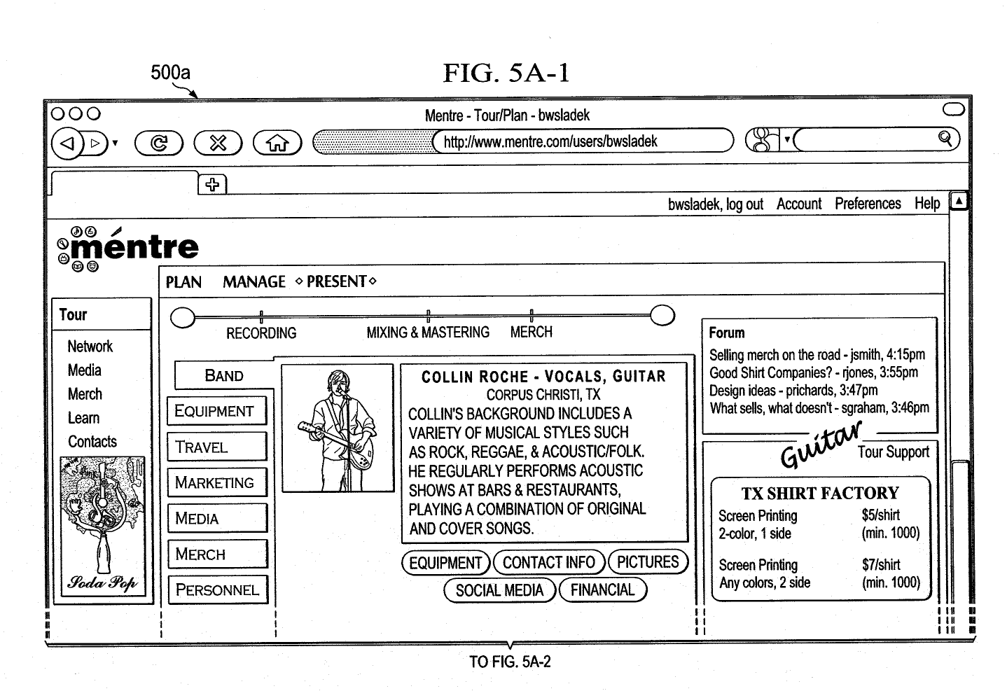

With regard to FIG. 4, a block diagram of an illustrative set of software modules 400 that may be utilized to form the event planner module 304 of FIG. 3 is shown. The modules 400 may include an event budgeting module. The event budgeting module 402 may enable a user to budget for an event. In budgeting for the event, the event budgeting module 402 may enable a user to create a budget by selecting specific aspects of the event and assigning a value to those aspects. For example, the user may enter a dollar amount for rental of sound & lighting equipment. Alternatively, the user may search the online community for sound & lighting equipment and select, by “dragging and dropping” or otherwise, prices for the sound & lighting equipment for use on a specific date range and geographic location. Alternatively, rather than creating a bottom-up budget estimate, a top-down estimate may be enabled by the event budgeting module 402. In the top-down estimate, the user enters the total budget for the event and the event budgeting module 402 creates budget estimates for each level of detail for the event being planned. The user may view a hierarchical list of the event plan as created by the event budgeting module 402 and drill down to whatever level of detail the user desires to see how the budget is set. The event budgeting module 402 may use a variety of different criteria for applying budgets to the individual items of the event, including a “rule-of-thumb” budgeting estimate to apportion a budget, historical budgeting by the user for past events, historical actual results of past events, budgeting percentages from other users who have created similar events in the same or different geographic region, etc. The event budgeting module 402 may thereafter allow the user to manually adjust the budget.

An event specification module 404 may enable the user to specify specific items of the event. In one embodiment, the event specification module 404 may provide a hierarchical listing of possible items for conducting an event. The hierarchical listing may be utilized by the user to expand or contract depending on the level of detail that the user desires. In one embodiment, the user may add additional items to create a unique list of items for an event depending on the user's needs or desires for conducting an event. In one embodiment, the hierarchical listing may be a generic event listing provided by a publisher of the online system. Alternatively, the user may utilize a hierarchical listing of another specific or anonymous user has allowed to be shared in the online community and that has put on a similar event in the same or different geographic area.

An event business plan generator module 406 may access the hierarchical listing created by the event specification module 404 and budgeting created by the event budgeting module 402 to create an event business plan. The event business plan created by the event business plan generator module 406 may create a business plan that is presentable either electronically or on paper to potential investors, sponsors, and/or donators for the event. In other words, the event business plan produces a formal business plan for conducting an event in a format that investors, sponsors, and/or donators of events are used to reading. The business plan output by the event business plan generator module 406 may provide an executive summary, overview, budgets, event plan specifications, hierarchical listing, and so forth.

An event execution plan generator module 408 may generate an event execution plan that provides Gant charts, requirements, specifications, and so forth so that every aspect of an artistic event is covered. The event execution plan generator module 408 may allow a user to enter specific details for conducting an event, such as the number of bartenders, waitresses, equipment handlers, etc., that are needed. In one embodiment, the event execution plan generator module 408 may allow the user to access data from previous events for use in populating a new event execution plan. As with the event business plan generator module 406, the module 408 may allow a user to access and use other published event execution plans that are available in the online community, thereby allowing the user to save time by following past event execution plans that were successful. By providing the user with the event execution plan, the user may be more confident that he or she is not going to miss an important item or timeline in putting on the event.

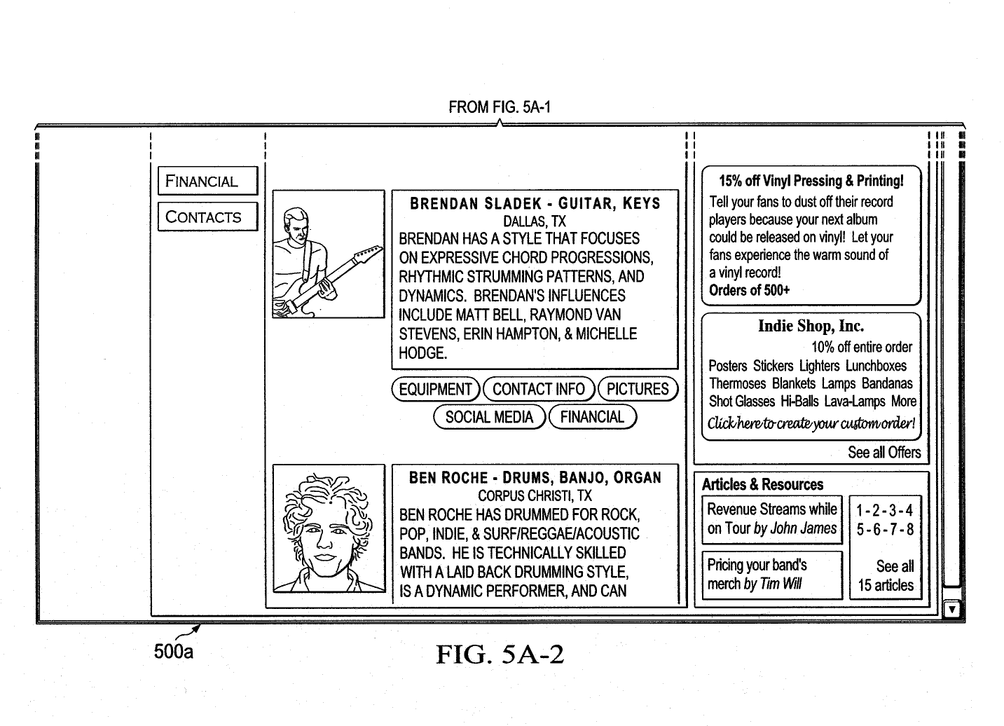

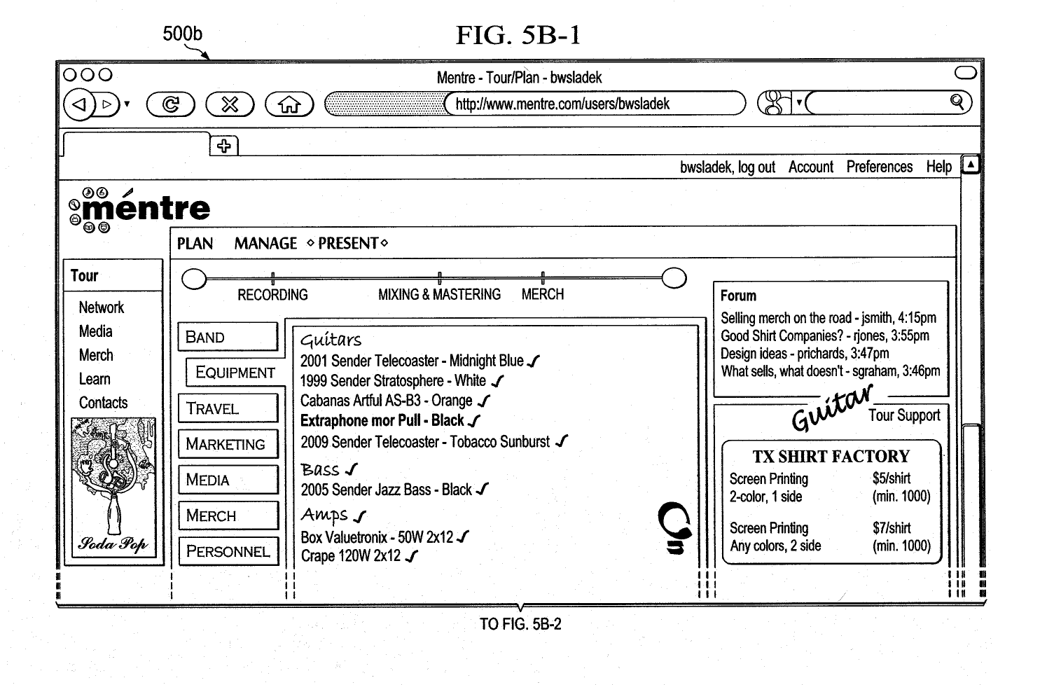

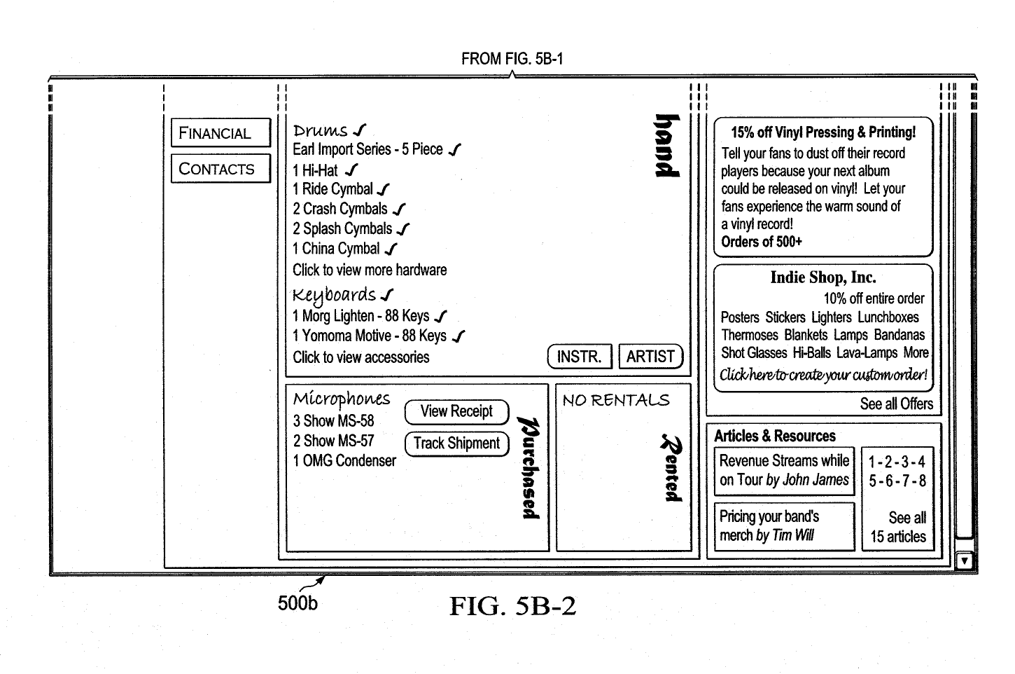

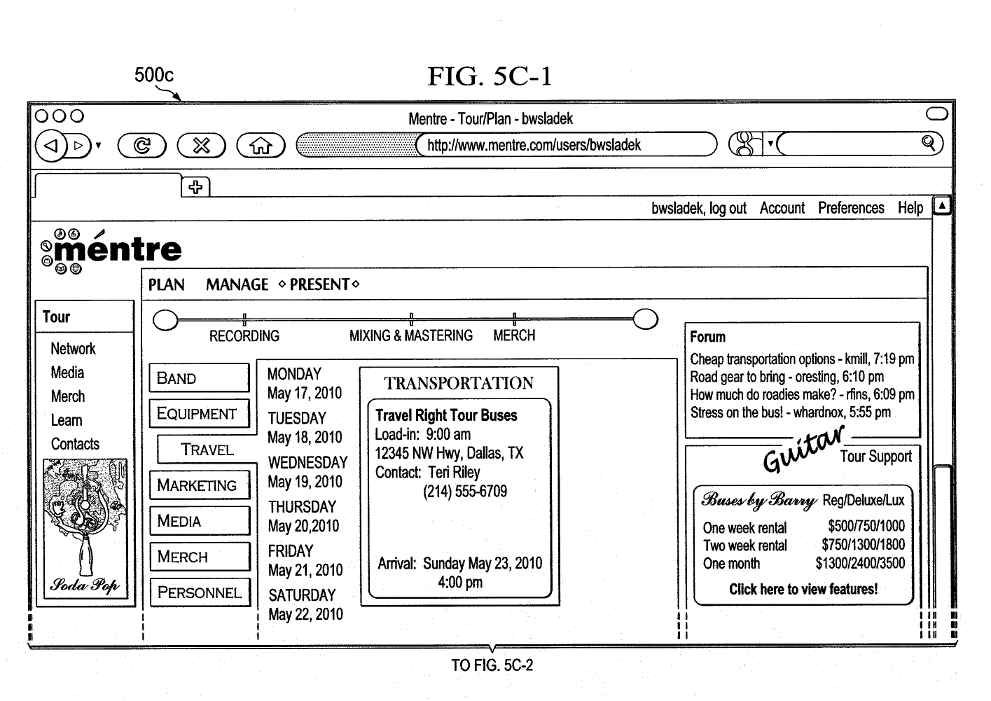

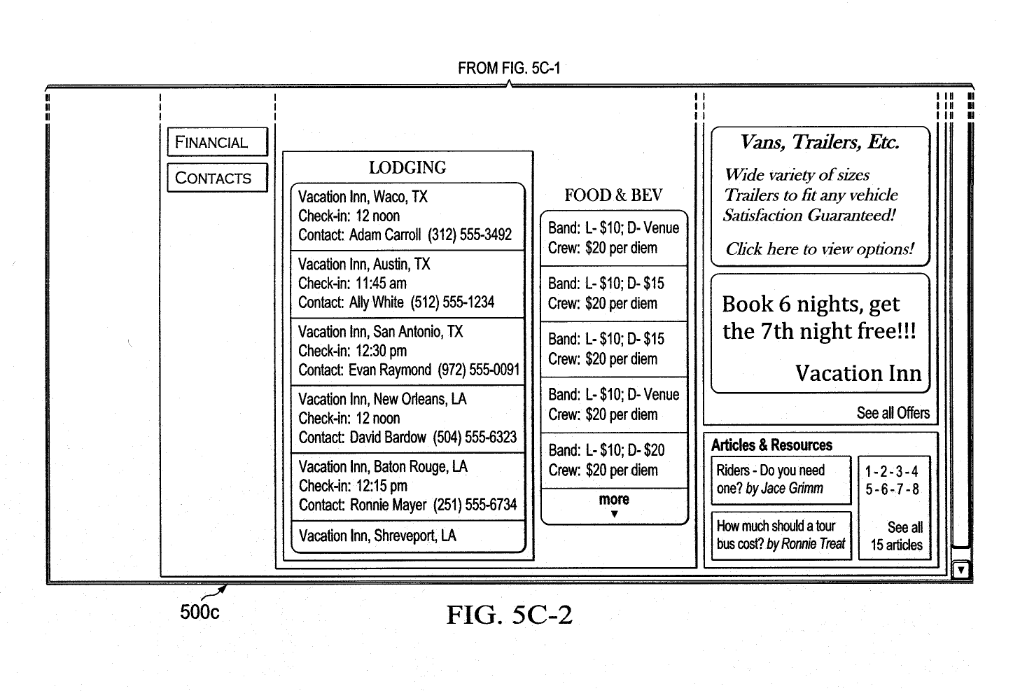

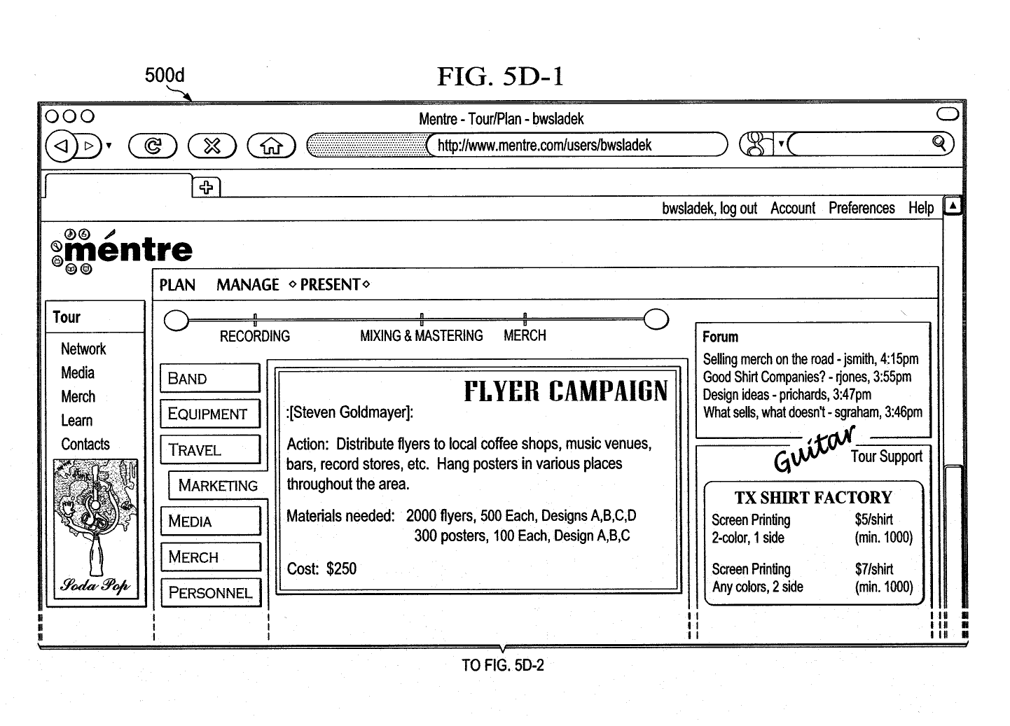

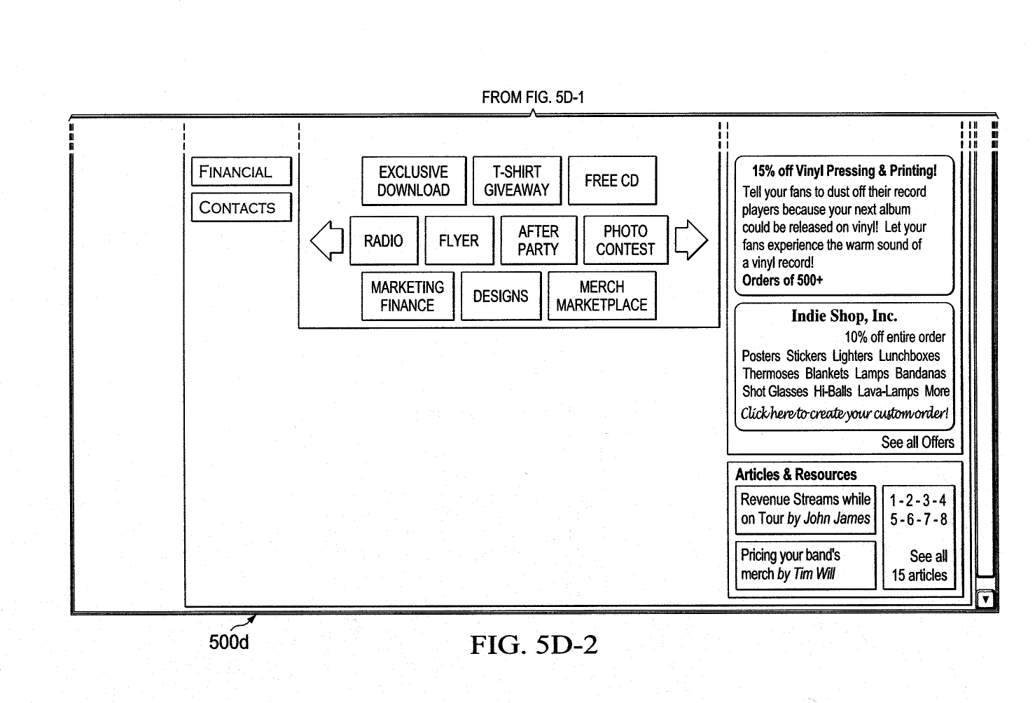

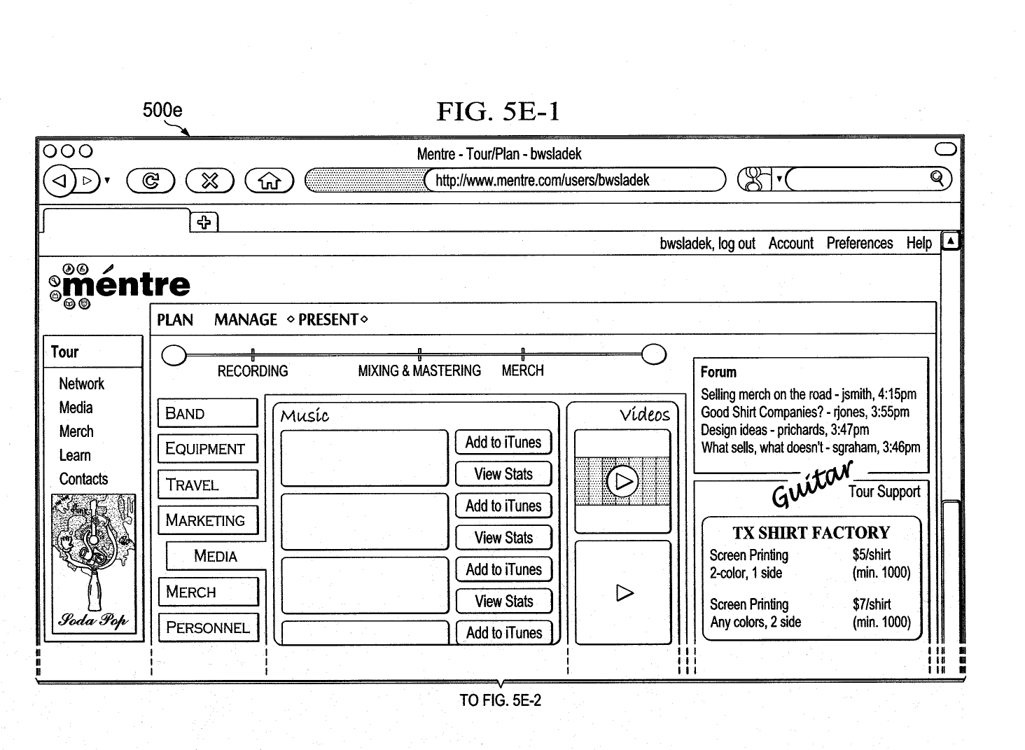

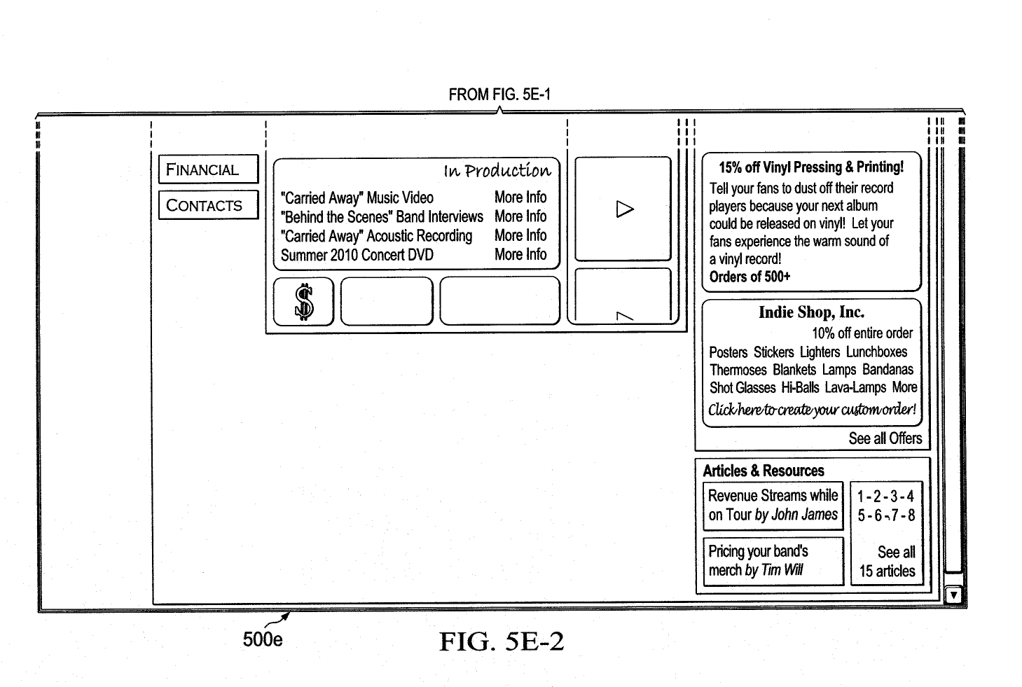

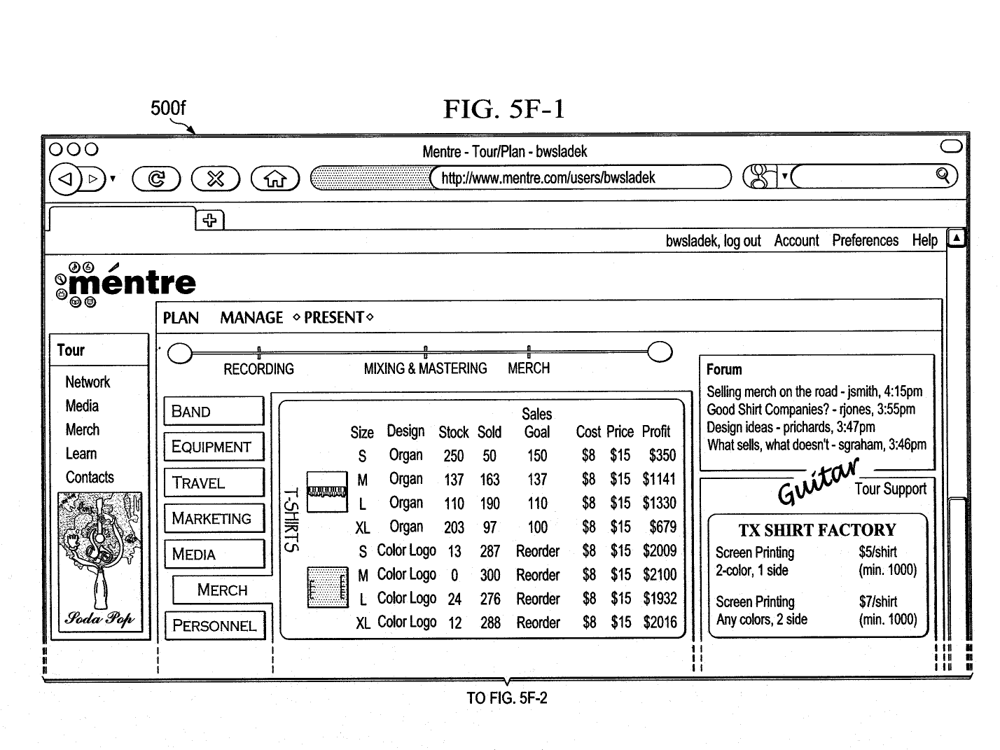

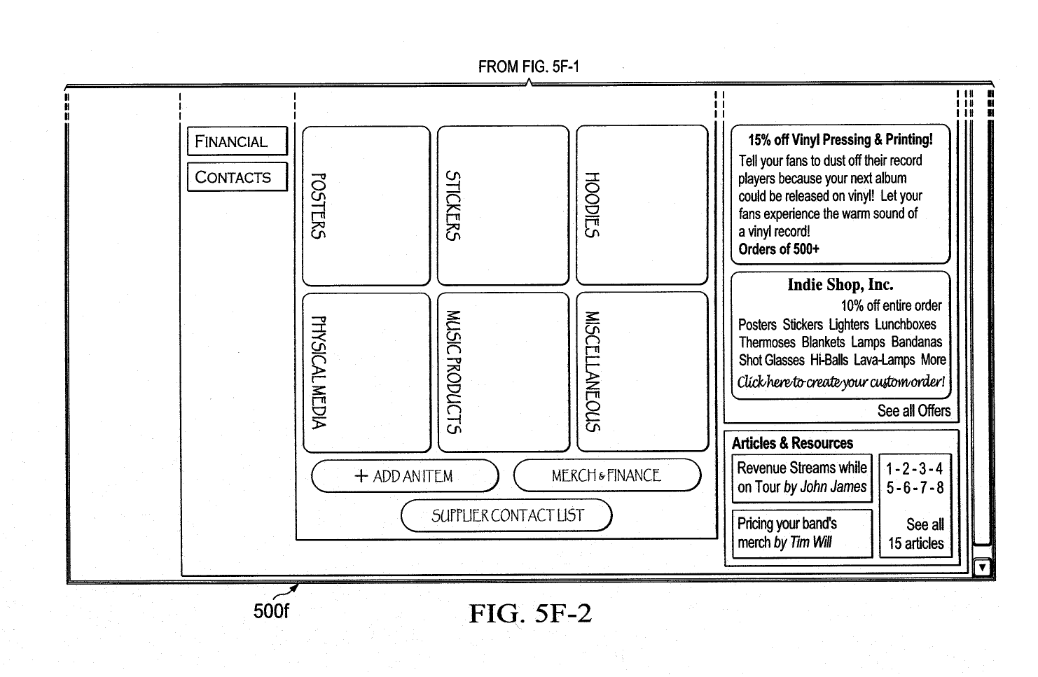

With regard to FIGS. 5A-5F, screenshots 500a-500f of illustrative input screens for an artist, in this case a band, to use in planning an event. The screenshots 500a-500f allow the user to enter specific information for creating an event business plan. As shown, screenshot 500a enables the user to enter information about the band. The information may include equipment, contact information, pictures, financial information, etc. This information may be “dragged and dropped” from profiles of other users in the online community when creating a band, which is a combination of the users selected. The information from each of the band members may include details that each band member inputs as needs or desires for performing at an event. As an example, if the band member is a keyboardist, then the needs may include specific amplifiers, specific keyboard(s), specific seats, dietary requirements before, during, or after a performance, availability calendar, and so forth so that the system can ensure that the event plans accommodate each of the band member needs.

Screenshot 500b provides for equipment input submission and/or review. As shown, specific equipment information is shown for conducting a show. In one embodiment, a listing of equipment vendors for sale or rental may be provided so that the user can select from the vendors to buy or purchase equipment needed for the event. Such selection may be performed in a number of different ways, as understood in the art.

Screenshot 500c includes travel plans for an event. Although not all events require travel, in the case where a particular does, then the travel plans can be created and used for the event planning. A listing of travel accommodations, including transportation, lodging, and food & beverages, may be provided to the user for selection and inclusion. In one embodiment, the travel accommodations listing may be limited based on the profiles of each of the band members. The listing may be limited to acceptable accommodations for all of the band members or on an individual band member basis.

The screenshot 500d provides for the user to create marketing needs and budget. The marketing needs may include memorabilia, radio, flyers, after party, photo gallery, and so on. The user may select specific marketing needs for a particular event. In one embodiment, budgets for each of the selected needs may be automatically populated based on standard or past events. As with other cases, the user may select to use the same planning of another online community user's event that was successful and was similar to the user's event.

The screenshot 500e provides media input that the user may elect to utilize to create online or physical marketing or sales. The user may apply a budget for creating and distribution of the media. A listing of vendors (e.g., reproduction houses), professionals (e.g., videographers), and so on may be displayed for selection. As with other modules, a standard or historical listing may be provided to the user. The media may be more or less detailed as selected in a hierarchical manner by the user.

Screenshot 500f allows the user to input merchandising needs or desires for the event. From the merchandising selection, budgets and timelines may be created for use in generating the event business and execution plans. As with other planning, the user may utilized previous merchandising plans of his or her own or of other users of the online community. Automatic and/or manual budgeting may be created for the merchandising.

It should be understood that the screenshots 500a-500f in FIGS. 5A-5F are illustrative and that screenshots that allow for a user to enter additional and/or alternative information for creating an event plan may be provided. For example, personnel, financial, and contact inputs may be provided. It should also be understood that while the screenshots 500a-500f show specific information that may be input for creating an artistic event business and execution plan, that other levels of inputs may be provided. As an example, the system may allow the user to enter desired event size, desired event location, desired event type, desired budget, desired revenue, desired profit, and so on and the system may automatically generate recommendations, levels of plan execution, budgets, and so forth based on the user's submissions. For example, the event business plan may output recommended marketing required to reach size/attendance goal, recommended venues, local artists/musicians by genre, personnel required/recommended, equipment (lighting/sound) recommended and so on. As another example, the event planning inputs may include marketing items, estimated reach, success percentage and yield, incentives and feedback mechanisms and have outputs of estimated attendance, analysis/feedback factors and tracking. Still yet, the inputs may include estimated attendance, revenue streams, price−cost=item net gain, estimated sales %×attendance−>estimated # sold and the output may include estimated revenues. In addition, the inputs may include expenses and estimated revenues and the output may include profit and sales tracking variables/tools.

In addition to the inputs and outputs, feedback of actual results as compared to budgets may be generated. In one embodiment, the event business plan may include a listing of historical budgets and actual results, thereby enabling the user to show how well he or she has planned for past events.

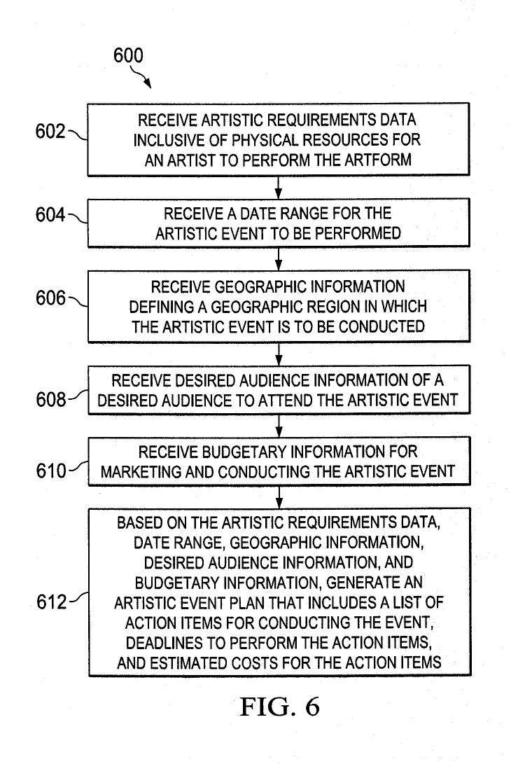

With regard to FIG. 6, a flow chart of an illustrative process 600 for planning an artistic event is shown. The process 600 starts at step 602, where artistic requirements data inclusive of physical resources for an artist to perform the art form is received. The artistic requirements data may be specific to the type of event and type of artist. In the case of a band, the physical resources may include sound and lighting equipment. At step 604, a date range may be received for the artistic event to be performed. The date range may be a single day, specific hours of the day, or multiple days and specific hours during those days. Geographic information defining a geographic region in which the artistic event is to be conducted may be received at step 606. The geographic information may include country, state, city, zip code, neighborhood, venue, or any other level of specificity of geography. At step 608, desired audience information of a desired audience to attend the artistic event may be received. The desired audience information may include demographic information, such as age range, gender, or other demographics, size of the audience, and so on. At step 610, budgetary information for marketing and conducting the artistic event may be received. In one embodiment, the event plan may be generated with estimated budgetary amounts for different aspects of the artistic event and may be automatically and/or manually generated as a function of a total budget, as previously described herein. That is, based on a total budget, the system may automatically apply certain percentages to different aspects of the event plan. The automatic application may be based on standard, historical, user profile pre-established settings, and so on. At step 612, based on the artistic requirements data, date range, geographic information, desired audience information, and budgetary information, an artistic event plan may be generated that includes a list of action items for conducting the event, deadlines to perform the action items, and estimated costs for the action items.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed:

1. A method for planning an artistic event, said method comprising:
receiving artistic requirements data inclusive of physical resources for an artist to perform the art form;
receiving a date range for the artistic event to be performed;
receiving geographic information defining a geographic region in which the artistic event is to be conducted;
receiving desired audience information of a desired audience to attend the artistic event;
receiving budgetary information for marketing and conducting the artistic event;
based on the artistic requirements data, date range, geographic information, desired audience information, and budgetary information, generating an artistic event plan that includes a list of action items for conducting the event, deadlines to perform the action items, and estimated costs for the action items.

2. The method according to claim 1, wherein generating an artistic event plan may include automatically generating budget estimates for different aspects of the event plan.
